(19) United States
(12) Patent Application Publication
(10) Pub. No.: US 2006/0206631 A1
(43) Pub. Date: Sep. 14, 2006

(54) Data duplication method and system used between USB devices

(76) Inventors: Chin-Chen Kuo, Taipei City (TW); Fok-Kei Loo, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/074,793

(22) Filed: Mar. 9, 2005

(51) Int. Cl. G06F 3/00

(52) U.S. Cl. 710/20

(57) ABSTRACT

A data duplication method and system used between USB devices is exploited to control data transmission between a source USB device and at least a target USB device without any assistance from a computer. The duplication system comprises at least a serial interface engine circuit, a CPU, and a data buffer unit. The CPU is connected to the source USB device and these target USB devices via these serial interface engine circuits. The CPU controls these serial interface engine circuits to transmit digital data in the source USB device to these target USB devices. The data buffer unit is connected to these serial interface engine circuits and the CPU, and is used to provide memory buffer space required during the digital data duplication process.

### BACKGROUND OF THE INVENTION

1. Field of the Invention

The present invention relates to a data duplication method and system used between USB devices and, more particularly, to a duplication system for digital data transmission used between USB devices and the duplication method for the same.

2. Description of Related Art

Of the transmission interfaces used in portable electronic products, the USB is the most popular. The USB specification evolved from the early USB 1.0 through USB 1.1 to the present USB 2.0. In addition to substantial enhancement of the transmission speed, the subsidiary specification USB OTG (On-The-Go) of USB 2.0 also provides a direct inter-transmission mechanism of file data between two USB OTG devices. Because not all USB 2.0 devices have the OTG function and there are still many USB 1.1 devices in use, it is necessary to use various computers if one wants to perform file duplication between two USB devices without the OTG function. The USB standard provides a unified transmission interface between computers and peripherals. Along with diversified development of consumer electronic products in the post-PC era, however, the requirement for direct inter-transmission of file data between devices becomes higher and higher. Although there is the USB OTG specification that can provide a direct inter-transmission mechanism of data between two devices with the USB OTG function, computers are still required for carrying out mutual file duplication for devices without the USB OTG function.

As shown in FIG. 1, file duplication between a personal digital assistant (PDA) 30 and a music player 40 is to be performed. It is necessary for these two devices to connect simultaneously to a computer 10 via an external or built-in hub 20. The computer 10 then executes an application software like the file explorer to duplicate a file from the PDA 30 to the music player 40, or vice versa.

As shown in FIG. 2, two USB devices 30 and 40 are connected to a computer 10. A serial interface engine (SIE) circuit of a hardware layer 102 in the computer 10 is responsible for low-level data transmission with USB devices. The computer 10 executes a related application program 106 to perform high-level communication with USB devices via a driver 1042. A file system 1044 in an operating system 104 is used to analyze file content in USB devices. Once the file contents of two USB devices have been analyzed, data duplication can be performed. Because people usually use a portable electronic product outdoors, when they want to share files with a handheld device of their friends, if these two devices have no OTG function or there is no computer available, file inter-transmission can not be carried out successfully.

### SUMMARY OF THE INVENTION

One object of the present invention is to provide a data duplication method and system used between USB devices so that two or more USB devices can perform inter-transmission of file data without any assistant from a computer.

A digital data duplication system of the present invention is used to control data duplication between a source USB device and at least a target USB device without any assistance from a computer. The duplication system comprises at least a SIE circuit, a CPU, and a data buffer unit. The CPU is connected to the source USB device and these target USB devices via these SIE circuits. The CPU controls these SIE circuits to transmit digital data in the source USB device to these target USB devices. The data buffer unit is connected to these SIE circuits and the CPU, and is used to provide memory buffer space required during the digital data duplication process.

A digital data duplication method of the present invention makes use of at least a storage block to provide space required during data duplication between a source USB device and at least a target USB device. The data duplication method comprises the steps of: analyzing the file content of digital data in the source USB device and the target USB devices; determining whether there is an empty storage block; reading digital data of the source USB device and storing the digital data, in order, into the storage blocks; determining, in order, whether the storage blocks are fully loaded with digital data; duplicating, in order, digital data in the storage blocks to the target USB devices; determining whether the duplication of all digital data of the source USB device is finished; and, finally, displaying a duplication-finish message.

The present invention has the following advantages:
1. File duplication between two USB devices can be performed without a computer:
The present invention proposes an embedded device to provide a file duplication function between USB devices without any computer.
2. The present invention is applicable to conventional USB devices:
The sub-specification OTG in the existent USB 2.0 specification can provide a data inter-transmission function between USB devices. A device having the host function can take other USB devices as peripherals and duplicate files thereto. Because the USB specification has been used for many years, most USB devices in use have no file inter-transmission function. The present invention can allow conventional USB devices to have the file inter-transmission function.
3. The file duplication speed is high:

File duplication of conventional USB devices is performed through the help of a computer. A computer, however, is a general-purpose tool and many functions may be carried out thereon, like getting internet access, printing, game playing, and so on. In multi-thread operating systems, the process of duplicating a large amount of files may take too much time. The present invention provides a special-purpose file duplication system and method to make use of a circular queue for simultaneously performing data read/write so as to process file duplication between two devices. Moreover, the memory capacity can be flexibly expanded.

### BRIEF DESCRIPTION OF THE DRAWINGS

The various objects and advantages of the present invention will be more readily understood from the following detailed description when read in conjunction with the appended drawing, in which:

FIG. 1 is a diagram showing the architecture of performing data inter-transmission between two USB devices through the help of a computer in the prior art;

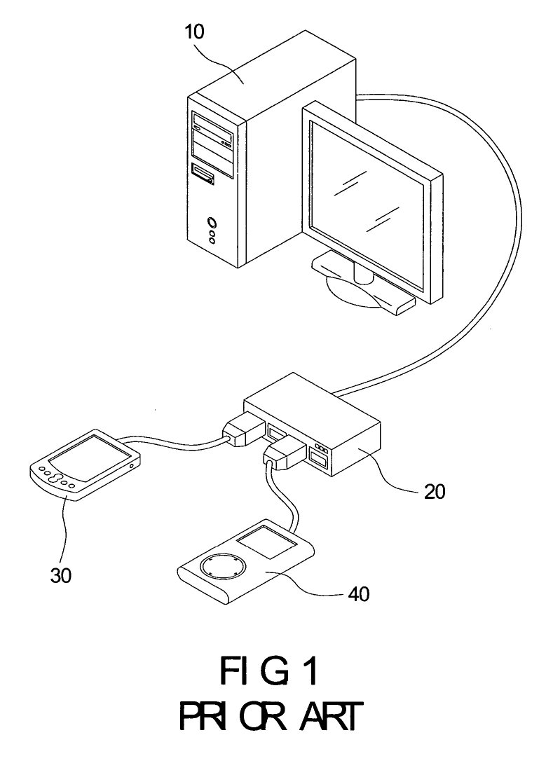

FIG. 2 is a block diagram showing the system of performing data inter-transmission between two USB devices through the help of a computer in the prior art;

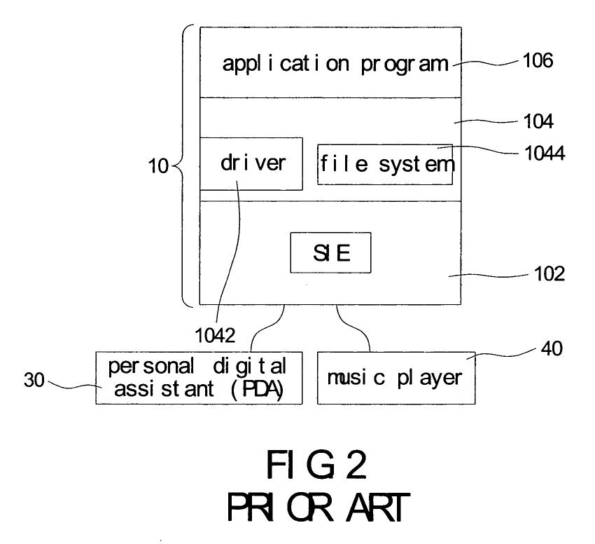

FIG. 3 is an architecture diagram of a digital data duplication system of the present invention;

FIG. 4 is a block diagram of a digital data duplication system of the present invention;

FIG. 5 is a diagram showing circular data storage used in the present invention; and

FIG. 6 is a flowchart of a digital data duplication method of the present invention.

### DETAILED DESCRIPTION OF THE PREFERRED EMBODIMENTS

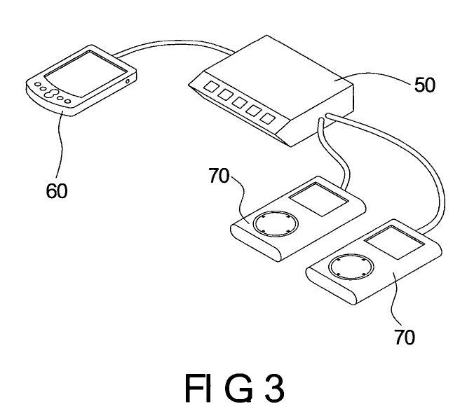

As shown in FIG. 3, a digital data duplication system 50 of the present invention is connected with a source USB device 60 and at least a target USB device 70. The digital data duplication system 50 can allow a user to duplicate files from a source device to a target device without any assistance from a computer.

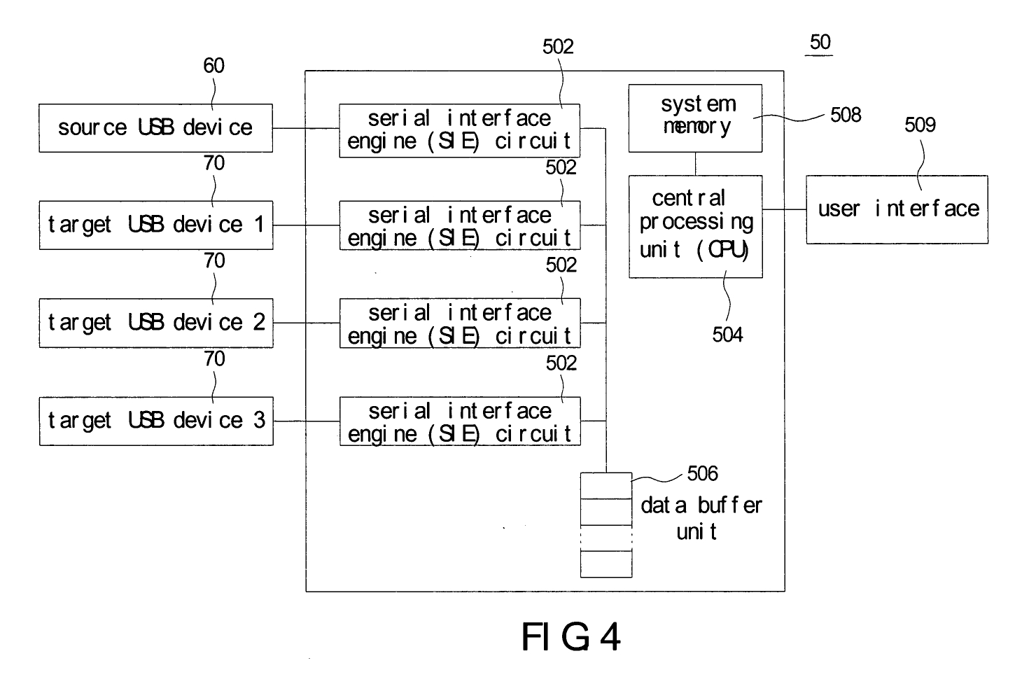

As shown in FIG. 4, the digital data duplication system 50 is connected between a source USB device 60 and at least a target USB device 70, and is used to control data duplication between USB devices. The digital data duplication system 50 comprises at least an SIE circuit 502, a CPU 504, and a data buffer unit 506. The SIE circuits 502 are connected to the source USB device 60 and the target USB devices 70. The CPU 504 is connected to these SIE circuits 502 for controlling them to transmit digital data in the source USB device 60 to the target USB devices 70. The data buffer unit 506 is connected to the SIE circuits 502 and the CPU 504, and is used to provide memory buffer space required during the digital data duplication process.

Reference is made to FIG. 4, again. The digital data duplication system 50 further comprises a system memory 508, which is connected to the CPU and used to store a firmware program. The CPU 504 executes the firmware program to duplicate data in the source USB device 60 to the target USB devices 70. The CPU 504 executes the firmware program to divide the data buffer unit 506 into at least a storage block. During data duplication, data of the source USB device 60 are stored, in order, into these storage blocks. The CPU 504 executes the firmware program to control the data buffer unit 506 to duplicate, in order, storage blocks fully loaded with data to the target USB devices 70.

As shown in FIG. 4, the digital data duplication system 50 further comprises a user interface 509 connected to the CPU 504. A user can makes use of the user interface 509 to transmit a working instruction to the CPU 504 for controlling data duplication of USB devices. The user interface 509 can be an indication light or an LCD.

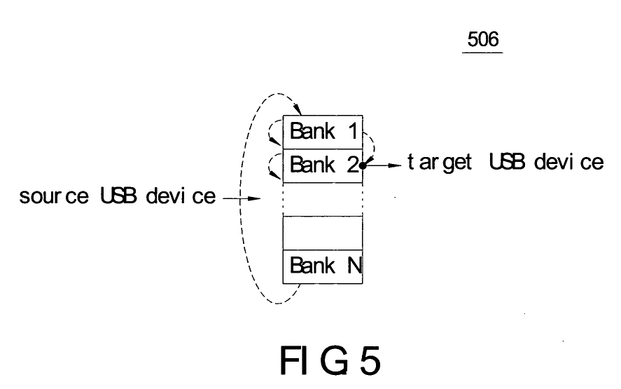

Reference is made simultaneously to FIG. 5 and FIG. 4. The CPU 504 divides the data buffer unit 506 into at least a storage block Bank 1, Bank 2 . . . Bank N. The capacity of the first storage block Bank 1 is designed to be the smallest. After a user starts file duplication between devices via the user interface 509, the CPU 504 controls the SIE circuit 502 connected to the source USB device 60 to drive the source USB device to function, and duplicates and transmits digital data in the source USB device to the data buffer unit 506, and stores data to the storage blocks starting from the first storage block Bank 1 with the smallest capacity. After a storage block is fully loaded with data, the CPU 504 will control the source USB device 60 to store continually, in order, to the next storage block. After the last storage block Bank N is fully loaded with data, the CPU 504 will control the source USB device 60 to store data back to the first storage block Bank 1, and the process is continued in the above order.

In the above data storage process, after a storage block is fully loaded with data, the CPU 504 will control the data buffer unit 506 to duplicate data in this storage block to the target USB devices 70. After duplication of this storage block is finished, the CPU 504 will mark this storage block as an empty storage block, determine whether the next storage block is fully loaded with data, and duplicate, in order, data to the target USB devices 70. Moreover, because the readout speed of memory is much higher than it's the write-in speed thereof, it is necessary to first determine whether a storage block for temporary storage is empty to prevent data overwrite when temporarily storing source file data.

As shown in FIG. 4, there are four SIE circuits 502 connected to USB devices (the number of SIE circuits is expandable). Which connection port is connected to the source USB device 60 is not fixed, but is set by the user interface 509. After set by the user interface 509, all remaining USB devices are target USB devices 70. The CPU 504 is the control core of the whole system, and executes the firmware program. The data buffer unit 506 provides memory buffer space required during the file duplication process. The user interface is an operation interface between the system and a user. For instance, a keyboard provides simple input for the user, and lights or an LCD displays related status and messages of the system.

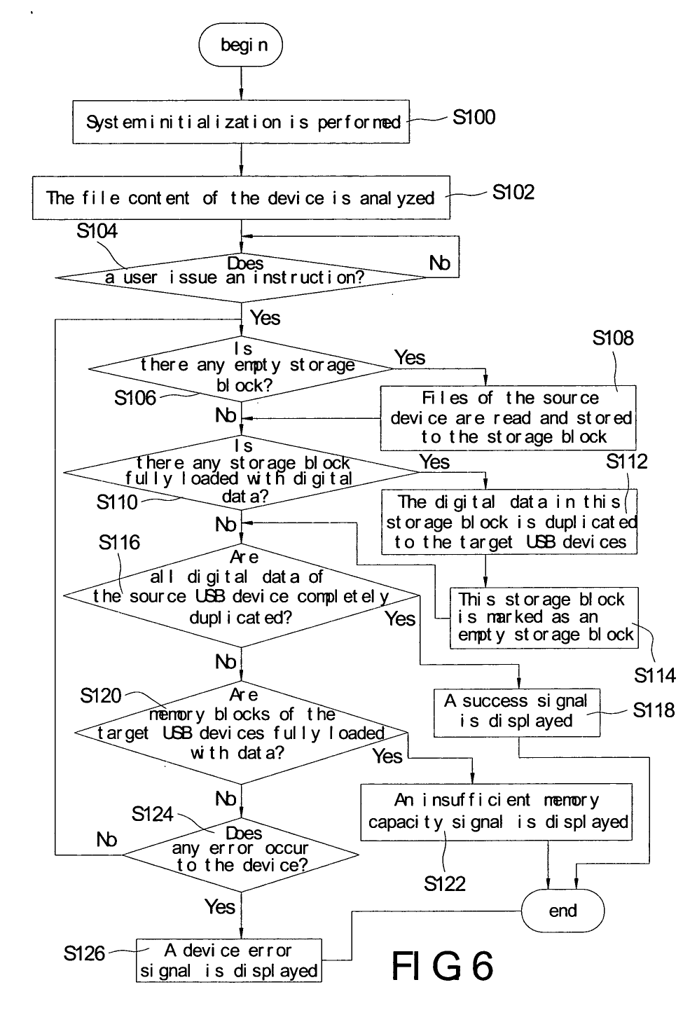

Reference is made simultaneously to FIG. 6 as well as FIG. 4. A digital data duplication method of the present invention makes use of at least a storage block to provide space required during data duplication between a source USB device and at least a target USB device. The data duplication method comprises the following steps. First, a self-initialization process of the digital data duplication system is performed (Step S100). After the source USB device is connected to the target USB devices, the file content of digital data in the USB devices is analyzed (Step S102). After analysis, file duplication is performed when a user issues a working instruction like a duplication instruction (Step S104). During the file duplication process, whether there is any empty storage block is first determined (Step S106). If the answer is yes, digital data of the source USB device is read and stored, in order, into these storage blocks (Step S108). Next, whether these storage blocks are fully loaded with digital data is determined in order (Step S110). If a storage block is fully loaded with digital data, the digital data in this storage block is duplicated to the target USB devices (Step S112), and this storage block is then marked as an empty storage block (Step S114). Subsequently, whether all digital data of the source USB device are completely duplicated is determined (Step SI 16). If the duplication is finished, the user interface will display a duplication-finish message (Step S118).

In Step S108, the read process can be separately performed. After a storage block is fully loaded with data, the next storage block will be used for storage. After the last storage block is fully loaded with data, the first storage block will be used for storage, again. Because the readout speed is much higher than the write-in speed, in order to prevent overwrite of temporary data, it is necessary to first determine whether a temporary block is empty when starting to store data into it. On the other hand, if any storage block is fully loaded with data, a separate procedure is performed to duplicate files therein to the target USB devices. After duplication of this storage block is finished, this storage block will be marked as an empty block.

After Step S116, if duplication of all files of the source USB device has not been finished yet, whether memory blocks of the target USB devices are fully loaded with data is determined (Step S120). If the answer is yes, the user interface will display that the memory capacity of the target USB devices is insufficient (Step S122). If the answer is no, whether any error occurs to the digital data duplication system is determined (Step S124). If the answer is yes, the user interface will display a device error signal. If the answer is no, the process returns to Step S106 of determining whether there is any empty storage block.

In the above illustrations, there are three kinds of end conditions in the flowchart of the present invention:
1. If the duplication of all files of the source USB devices has been finished, a work-successful signal will be displayed.
2. If the memory of the target USB devices is used up, a memory-insufficient signal will be displayed.
3. When readout or write-in of file fails all the time and a threshold is reached, a device error signal will be displayed.

To sum up, the present invention provides a data duplication method and system used between USB devices so that two or more USB devices can perform inter-transmission of file data without assistance from a computer. The present invention has the following advantages:
1. File duplication between two USB devices can be performed without a computer.
2. The present invention is applicable to conventional USB devices.
3. The file duplication speed is high.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A digital data duplication system for controlling data duplication between a source USB device and at least a target USB device, said digital data duplication system comprising:
at least a serial interface engine circuit, respectively connected to said source USB device and said target USB devices;
a CPU connected to said serial interface engine circuits for controlling said serial interface engine circuits to perform simultaneously data read/write by using a circular queue so as to duplicate digital data in said source USB device to said target USB device; and
a data buffer device connected to said serial interface engine circuits and said CPU, and used to provide memory buffer space required during a digital data duplication process.

2. The digital data duplication system as claimed in claim 1, further comprising a system memory connected to said CPU for storing a firmware program, wherein said CPU executes said firmware program to duplicate data in said source USB device to said target USB devices.

3. The digital data duplication system as claimed in claim 1, wherein said CPU divides said data buffer unit into at least a storage block, and said CPU stores, in order, data of said source USB device into said storage blocks during the data duplication process.

4. The digital data duplication system as claimed in claim 3, wherein said CPU controls said data buffer unit to duplicate data stored in fully loaded storage blocks to said target USB devices.

5. The digital data duplication system as claimed in claim 1, further comprising a user interface connected to said CPU, wherein said user interface is used to transmit a working instruction to said CPU for control of data duplication.

6. The digital data duplication system as claimed in claim 1, further comprising a user interface connected to said CPU, wherein said user interface is an indication light or an LCD.

7. A digital data duplication method making use of at least a storage block to provide space required during data duplication between a source USB device and at least a target USB device, said duplication method comprising:
analyzing a file content of digital data in said source USB device and said target USB devices;
determining whether any empty storage blocks exist;
reading digital data of said source USB device and storing the digital data, in order, into said storage blocks;
determining, in order, whether said storage blocks are fully loaded with digital data;
duplicating, in order, digital data in said storage blocks to said target USB devices;
determining whether duplication of all digital data of said source USB device is finished; and
displaying a duplication-finish message;

8. The digital data duplication method as claimed in claim 7, further comprising a step of issuing a working instruction to perform digital data duplication after said step of analyzing the file content of digital data in said source USB device and said target USB devices.

9. The digital data duplication method as claimed in claim 7, wherein digital data stored in a storage block is duplicated to said target USB devices if said storage block is fully loaded with digital data, and said storage block is then marked as an empty storage block after said step of determining, in order, whether said storage blocks are fully loaded with digital data.

10. The digital data duplication method as claimed in claim 7, further comprising a step of determining whether all memory blocks of said target USB devices are fully loaded if an answer is no in said step of determining completion of duplication of all digital data of said source USB device.

11. The digital data duplication method as claimed in claim 10, further comprising a step of displaying indicating insufficient memory capacity of said target USB devices if the answer is yes in said step of determining whether all memory blocks of said target USB devices are fully loaded.

12. The digital data duplication method as claimed in claim 10, further comprising a step of determining whether any error occurs to said digital data duplication device if the answer is no in said step of determining whether all memory blocks of said target USB devices are fully loaded.

13. The digital data duplication method as claimed in claim 12, further comprising a step of displaying a device error signal if the answer is yes in said step of determining whether any error occurs to said digital data duplication device.

14. The digital data duplication method as claimed in claim 12, further comprising a step of jumping back to said step of determining whether any empty storage blocks exist if the answer is no in said step of determining whether any error occurs to said digital data duplication device.
